(19) United States
(12) Patent Application Publication
(10) Pub. No.: US 2017/0083620 A1
(43) Pub. Date: Mar. 23, 2017

(54) Techniques for Exploring Media Content

(71) Applicant: SAP SE, Walldorf (DE)

(72) Inventors: Kok Thim Chew, Milbrae, CA (US); Alexander Schaefer, Sunnyvale, CA (US); Shriniket Kale, Cupertino, CA (US)

(21) Appl. No.: 14/858,889

(22) Filed: Sep. 18, 2015

(51) Int. Cl. G06F 17/30

(52) U.S. Cl. CPC G06F 17/30719; G06F 17/30038

(57) ABSTRACT

Various techniques are described for assisting a learner in exploring media content. The system can provide recommended search topics to drill down into the search query. This can assist the learner in quickly finding relevant media. The solutions can also provide a text snippet summary that contains a collection of transcribed sentences from a media search result. Each transcribed sentence contains the search query. By reviewing the text snippet summary, a learner can obtain some context to the media search result without selecting the media search result. A preview for a search result can also be generated. The preview contains snippets of the media file which contain keywords of the media file. The media player can highlight the most viewed sections of the media along the time line and can highlight sections of the media which contain a keyword when a keyword is selected.

### BACKGROUND

Terabytes of content ranging from educational to entertainment are available on the Internet today. The content can be delivered in various formats including text, audio, and video. As a result, learners often use the Internet as valuable resource. However, finding relevant media on the Internet can be a cumbersome task due to the massive amount of content that is available. This is particularly true for media that is in audio format or video format. Traditional search engines return matches to a search query based on metadata stored on the media content rather than the actual media content. As a result, the search results that are of interest to the learner can be difficult to find. Once relevant media has been found, the learner may also have difficulties locating the portions of the media that are of interest to the learner. For example, the learner may have difficulty locating portions of a one hour video that are relevant to the search query.

There is therefore a need for improved techniques for exploring media content.

### SUMMARY

In one embodiment, a computer-implemented method receives, by a processor, a request to generate a preview of a media file. The method then identifies, by the processor, a keyword associated with the media file. The method then captures, by the processor, at least one snippet from the media file in accordance to the keyword. The method then combines, by the processor, the at least one snippet into a preview file, wherein the preview file is configured to provide a summary of the media file.

In one example, the keyword characterizes the media file.

In another example, capturing the at least one snippet includes retrieving, by the processor, a transcript containing a text version of audible content within the media file and querying, by the processor, the transcript to identify an entry within the transcript that contains the keyword. The transcript can include a plurality of entries, wherein the entry includes text that transcribes a snippet of the media file, a start time describing when an audible version of the text begins within the media file, and an end time describing when the audible version of the text ends within the media file. Capturing the at least one snippet from the media file further can include copying, by the processor, the snippet from the media file based on the start and the end time of the entry. The snippet can include a portion of the media file that begins at the start time and ends at the end time

In another example, combining the at least one snippet into the preview file can include determining, by the processor, an insertion point for the snippet into the preview file which would maintain the chronological ordering of other snippets within the preview file and inserting, by the processor, the snippet at the insertion point/

In another embodiment, a non-transitory computer readable storage medium stores one or more programs comprising instructions for: receiving a request to generate a preview of a media file, identifying, by the processor, a keyword associated with the media file, capturing at least one snippet from the media file in accordance to the keyword, and combining the at least one snippet into a preview file, wherein the preview file is configured to provide a summary of the media file.

In another embodiment, a computer implemented system comprises one or more computer processors memory; and one or more programs. The one or more programs are stored in the memory and configured to be executed by the one or more processors. The one or more programs include instructions for: receiving a request to generate a preview of a media file, identifying, by the processor, a keyword associated with the media file, capturing at least one snippet from the media file in accordance to the keyword, and combining the at least one snippet into a preview file, wherein the preview file is configured to provide a summary of the media file.

The following detailed description and accompanying drawings provide a better understanding of the nature and advantages of the present disclosure.

### BRIEF DESCRIPTION OF THE DRAWINGS

FIG. 1 illustrates a system for exploring media content according to one embodiment.

FIG. 2 illustrates an exemplary table formatting for media transcripts according to one embodiment.

FIG. 3 illustrates a system for loading media according to one embodiment.

FIG. 4 illustrates a system for generating keywords for media according to one embodiment.

FIG. 5 illustrates a main page of a GUI for exploring media content according to one embodiment.

FIG. 6 illustrates a process flow for deriving suggested search terms from a search query according to one embodiment.

FIG. 7 illustrates a media details page according to one embodiment.

FIG. 8 illustrates a portion of a media details page according to one embodiment.

FIG. 9 is an example block diagram illustrating an example computing system for debugging in a production environment, in accordance with one embodiment.

### DETAILED DESCRIPTION

Described herein are techniques for exploring media content. The apparatuses, methods, and techniques described below may be implemented as a computer program (software) executing on one or more computers. The computer program may further be stored on a non-transitory computer readable medium, such as a memory or disk, for example. A computer readable medium may include instructions for performing the processes described below. In the following description, for purposes of explanation, numerous examples and specific details are set forth in order to provide a thorough understanding of various aspects of the present disclosure. It will be evident, however, to one skilled in the art that embodiments of the present disclosure as defined by the claims may include some or all of the features in these examples alone or in combination with other features described below, and may further include modifications and equivalents of the features and concepts described herein.

The implementations described herein provide various technical solutions for exploring and consuming media content. First, the solutions can provide recommended search topics to assist the learner in quickly locating relevant media. Based on a learner's search query, the system is capable of providing recommend search topics to drill down into the search query. Second, the solutions can also provide a text snippet summary for each media search result that provides context to the media search result. A text snippet summary is a collection of transcribed sentences from a media search result. Each transcribed sentence contains the search query. By reviewing the text snippet summary, a learner can obtain some context to the media search result without selecting the media search result.

Third, the solutions can present a media player to playback media content, which can be in an audio or video format. A preview of the media item can also be generated. The preview can provide a trailer of a selected media result. In one embodiment, the preview can contain snippets of the selected media result that contain words from the search query. In another embodiment, the preview can contain snippets of the audio or video based on the snippet's view count, comments, or content. Four, the solutions can provide a tag cloud along with the media player. The tag cloud presents keywords of the selected media result. The size and/or placement of a particular keyword in the tag cloud can be based on factors associated with the keyword such as the keyword's weight or importance. Upon selection of a keyword in the tag cloud, the system can present cue points along the time line of the video player to indicate the time index within the media where the keyword appears. This can assist the learner in skipping to the section of the media that is mentions the keyword. Most viewed sections of the media can also be highlighted in the timeline of the media player to identify snippets of the media which may be of interest to the learner.

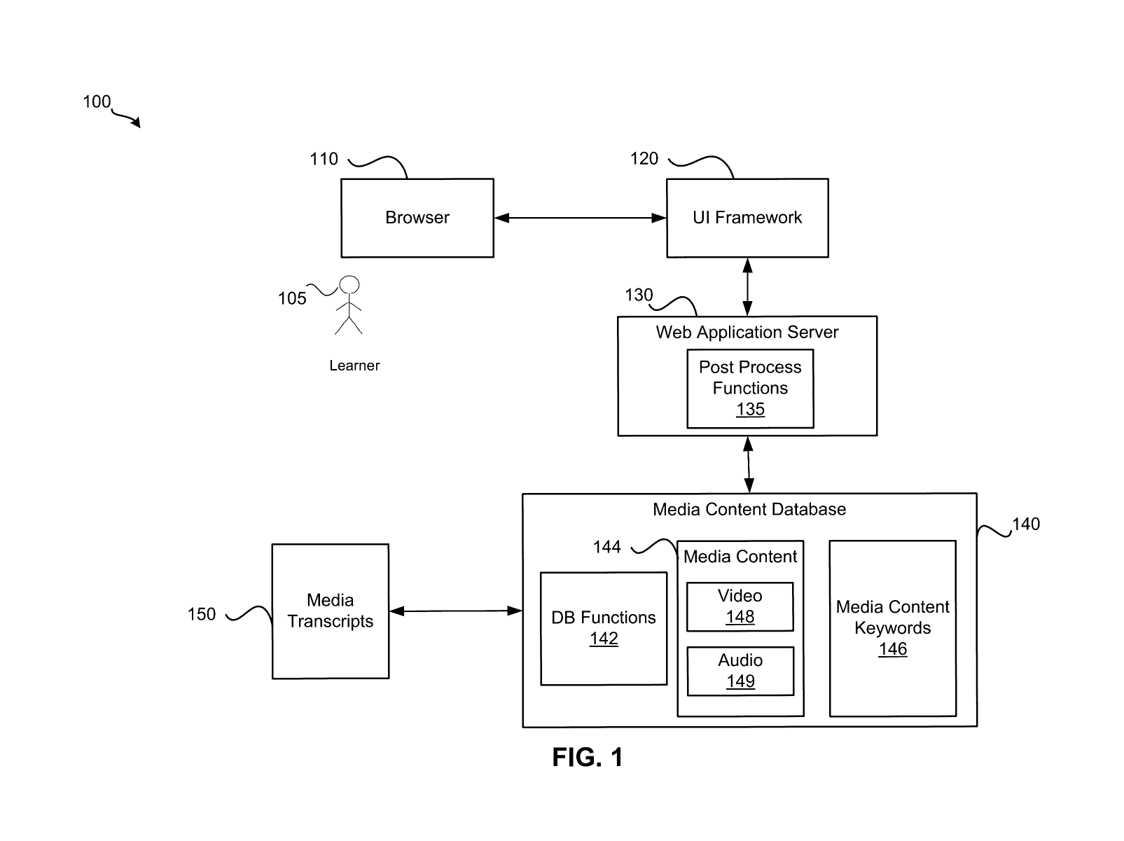

FIG. 1 illustrates a system for exploring media content according to one embodiment. System 100 includes browser 110, UI framework 120, web application server 130, media content database 140, and media transcripts 150. Media content database 140 stores media content 144, which can include video content 148 and audio content 149. Media content database 140 also includes database functions 142 to analyze and manipulate media content 144. One database function can perform text analysis to generate a transcript from an audio or video file. The generated media transcript can be stored within media transcripts 150. As a result, each media within media content 144 can include a corresponding media transcript within media transcripts 150. Another database function can generate keywords for a media within media content 144. Each media within media content 144 can include one or more keywords that characterize the media. The keywords can be stored within media content keywords 146. In one embodiment, media content database 140 can be configured as a columnar in-memory database architecture such as SAP HANA to achieve fast processing times.

Browser 110 is in communication with media content database 140 via UI framework 120 and web application server 130. UI framework 120 forms the frontend framework while web application server 130 forms the backend framework. As part of the frontend framework, UI framework 120 is configured to generate a user interface that is capable of presenting media audibly or visually within browser 110. The user interface can include a media player. UI framework 120 is also configured to process instructions received from the user interface via browser 110. UI framework 120 can interpret the instructions and provide the interpreted instructions to web application server 135 where the instructions can be processed. Web application server 135 can include post process functions 135 which are configured to process search results or the media content before passing the information to UI framework 120 to generate the user interface that is presented within browser 110. In some embodiments, the frontend framework and the backend framework can be developed in the same programming language, such as Javascript.

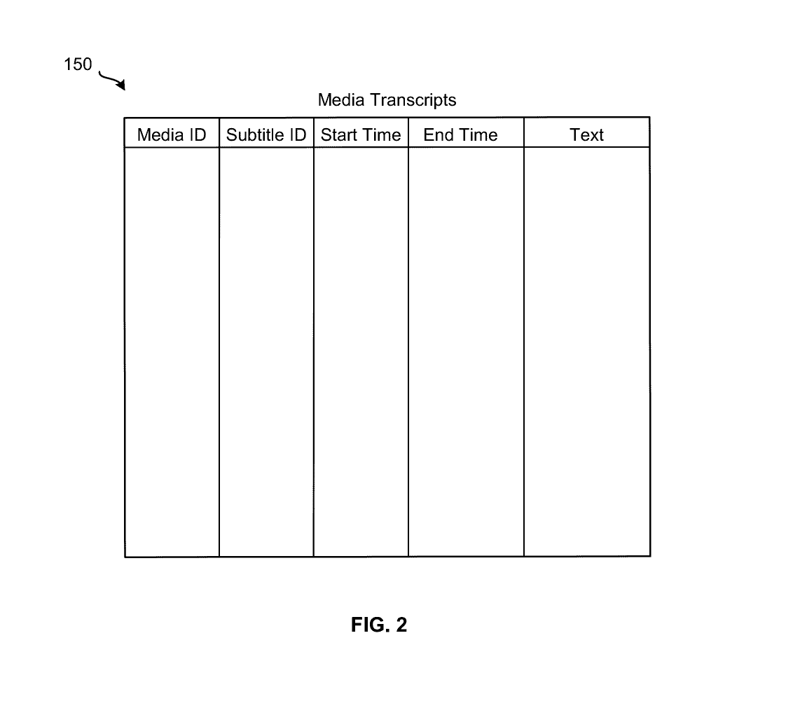

FIG. 2 illustrates an exemplary table formatting for media transcripts according to one embodiment. Media transcripts 150 is configured to store the transcripts of text, audio, or video files stored within media content database 140. For audio or video, the transcript is a textual representation of the media. Each entry within media transcripts 150 include multiple fields which represent a segment of the transcript. In this example, the fields include media ID, subtitle ID, start time, end time, and text however in other examples, media transcripts 150 can include more or fewer fields in a different order. Media ID can store the unique ID of a transcript for a media file, which can be text, audio, or video. This allows one transcript to be distinguished from another. As stated above, each transcript can be broken into multiple segments. In one example, each segment can be a sentence within the transcript. In another example, each segment can represent a period of time within the media (e.g., segment 1 is the first minute of the video and segment 2 is the second minute of the video). Each segment of the transcript can be assigned a subtitle ID that is unique for the transcript. Thus in a collection of transcripts, the combination of the media ID and the subtitle ID can uniquely identify a particular segment of a particular transcript. The start time and end time field can store the start time and end time of the audio/video segment that corresponds to the segment of the transcript. The text field stores the text of the segment of the transcript.

### Loading Media

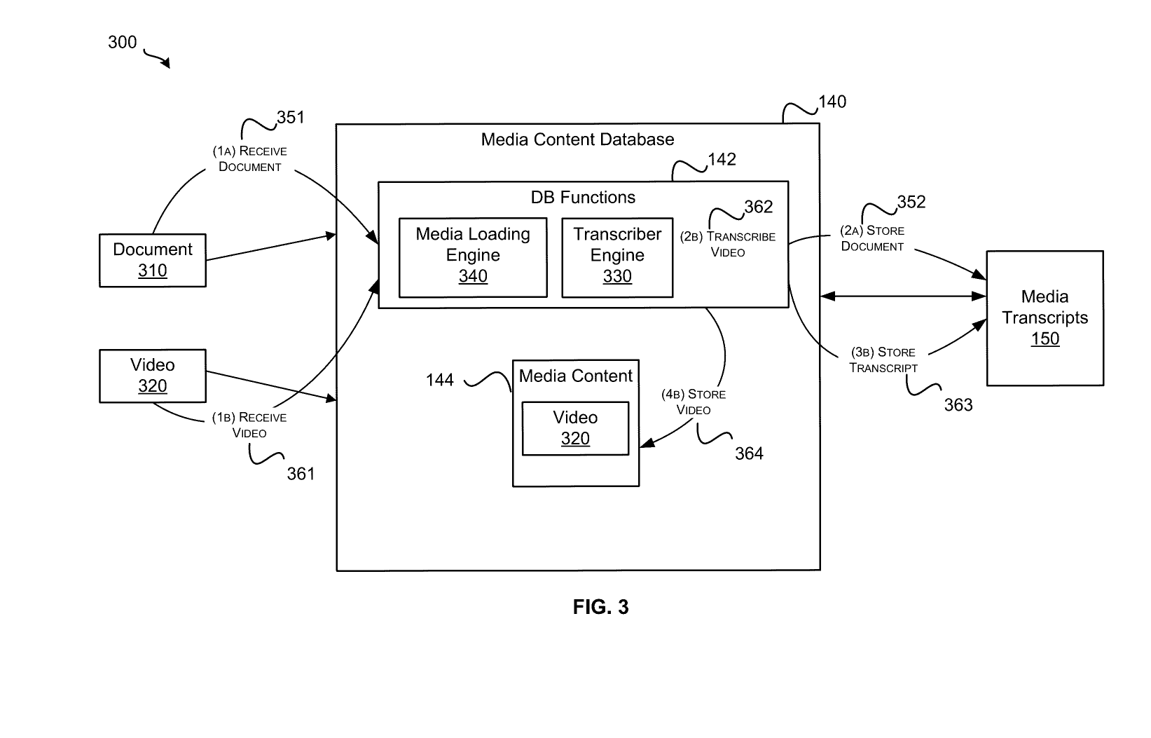

Media content to be explored can first be loaded into the media content database. FIG. 3 illustrates a system for loading media according to one embodiment. As shown, system 300 includes media content database 140. Media content database 140 stores database functions 142, one of which is transcriber engine 330. Transcriber engine 330 is configured to process audio or video by transcribing words spoken in the audio or video into text which is stored within a transcript. In other words, the transcript is a textual representation of the audio or video. In other embodiments, transcripts can already exist and be imported along with the media. In those scenarios, transcriber engine 330 may not be necessary or may not be a part of system 300.

System 300 also illustrates two process flows for storing media in the media content database 140. The first process flow is for loading text documents. First, media loading engine 340 of media content database 140 can receive document 310 at step 351. Media loading engine 340 can determine that the type of media that is received is in a text format. Upon the determination, media loading engine 340 can store document 310 within an entry of media transcripts 150. Media that is in text format can be considered a transcript and directly stored within an entry of media transcripts 150. The media ID field of the entry would store a unique identifier that is associated with the text document and the text field of the entry would store the text of the text document. The remaining entries (e.g. subtitle ID, start time, and end time) can remain unset or blank.

A second process flow is for loading audio or video files. First, media loading engine 340 can receive video 320 at step 361. Media loading engine 340 can determine that the type of media received is an audio or video format. Upon the determination, media loading engine 340 can pass video 320 to transcriber engine 330 to transcribe the video at step 362. Once the transcript is generated, media loading engine 340 can store the transcript in media transcripts 150 at step 363. The transcript can be broken into multiple segments according to one or more rules (e.g., by sentence, by time, etc.). Each segment of the transcript can be stored as a separate entry within media transcripts 150.

### Generating Keywords

In some embodiments, keywords can be derived from media content stored within media content database 140. Each keyword can signify an important word or phrase found within the media content. As such, a review of the media's keywords can provide an overview or summary of important topics within the media. The process for generating keywords is also known as tokenization. Tokenization is the breaking down of text into its constituent words, phrases, or other basic elements.

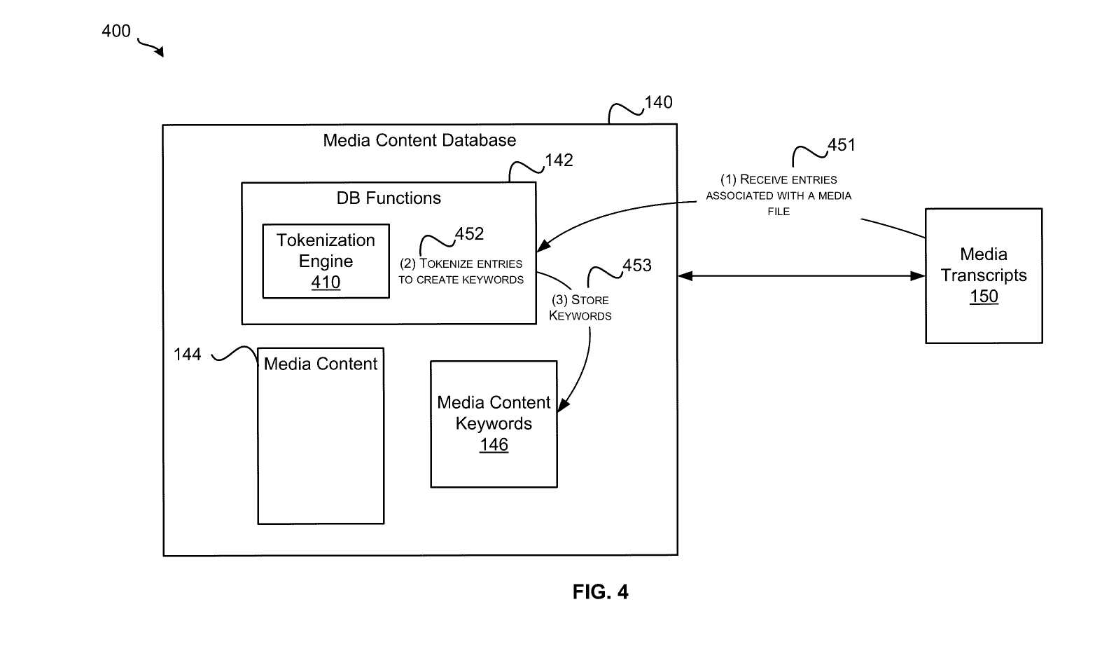

FIG. 4 illustrates a system for generating keywords for media according to one embodiment. System 400 includes media content database 140 and media transcripts 150. Media content database 140 can store previously loaded media. Video and audio files can be stored within media content 144 with a corresponding transcript in media transcripts 150. Text files can be stored as a transcript within media transcripts 150. Media content database 140 can also store database functions 142, which include tokenization engine 410.

Tokenization engine 410 is configured to receive a transcript and to derive keywords from the transcript. System 400 illustrates a process flow for tokenizing a transcript. First, tokenization engine 410 can receive entries associated with a media file at step 451. For text documents, a single entry containing text from the text document can be received. For audio or video, multiple entries containing the transcript of the audio or video file can be received. Once the entries have been received, tokenization engine 410 can tokenize the entries to create keywords at step 452. Once the keywords have been generated, tokenization engine 410 can store the keywords within media content keywords 146 at step 453. Each keyword stored within media content keywords 146 can be associated with at least one transcript within media transcripts 150.

### Searching for Media

Once the media has been loaded into the system and keywords have been generated for the loaded media, the system is ready to process search requests. Search requests can be entered into a search bar of a graphical user interface (GUI). The GUI can be generated by post process functions 135 of web application server 130 or database functions 142 of the media content database 140. In some embodiments, the GUI can include features which allow the learner to better explore the media within media content database. These features are described in further detail below.

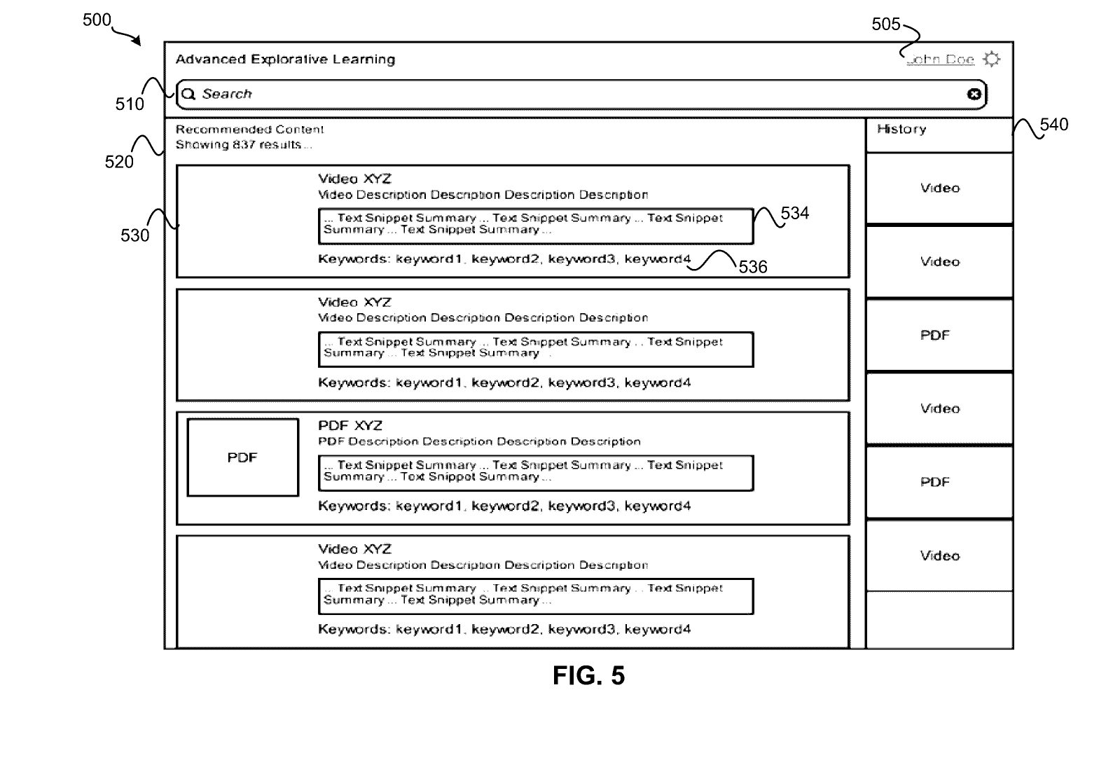

FIG. 5 illustrates a main page of a GUI for exploring media content according to one embodiment. As shown, main page 500 includes search bar 510, results window 520, and history window 534. Search bar 510 is configured to receive a search request from the learner in the form of a text string. A search function (within media content database 140) can process the search request to generate search results which are presented in separate tiles within results window 520. For example, tile 530 presents a single search result. The search function can generate a score for each media in media content database for a given search query. The score indicates the relevance of the particular search result with respect to the search query. In one example, the score is calculated on factors such as text ranking based on the TF-IDF score (term frequency-inverse document frequency) which reflects the importance of a term in a particular text amongst a collection of text documents.

In one embodiment, the search function can utilize a transcript corresponding to a media item when generating the score for the media item. By using the transcript of the media item (particularly for audio and video files) rather than the description of the media item, the generated score can more accurately reflect the relevance of the media item. For instance, a description of a video may include a few sentences that summarize what the video is about. Generating a score based on the video description and the search query can result in a subpar relevance score since the entire context of the video is not provided in the video description. In contrast, generating a score based on the video transcript and the search query can result in a more accurate relevance score since all the spoken words in the video can be processed in generating the relevance score. Once the search results have been generated, the search results can be presented within main page 500. In other embodiments, main page 500 can present results in results window 520 prior to receiving a search query from the learner. For example, results can be recommended to the learner based on the learner's viewing history or preferences. Media which was recently viewed by the learner can be presented in history window 534. In another example, results can be presented in results window 520 based on the last search query performed by the learner. This allows the learner to continue from where he or she left off.

### Text Snippet Summary

In some embodiments, post process functions 135 can enhance the search results by providing additional context. The additional context can assist the learner in identifying search results that are of interest. In one embodiment, a function can generate text snippet summary 534. The function can query the transcript of the media file for sentences or phrases which contain the search query. Thus, the text snippet summary 534 presents a collection of sentences or phrases from the transcript of the media where each sentence or phrase contains the text from the search query. By providing these text snippets, the learner is able to ascertain the context of the search result without having to open the search result. As shown, the text snippets can be presented within text snippet summary 534. Keywords list 536 can also be presented along with each search result. The keywords list 536 can contain keywords that are associated with the media file. In one example, a predefined number of keywords can be presented in keywords list 536 (e.g., top 4 keywords of the media file). As a result, the learner can review keywords list 536 to ascertain a general context of the media file and can review text snippet summary 435 to ascertain a specific context that is based on the search query.

### Suggested Search Terms

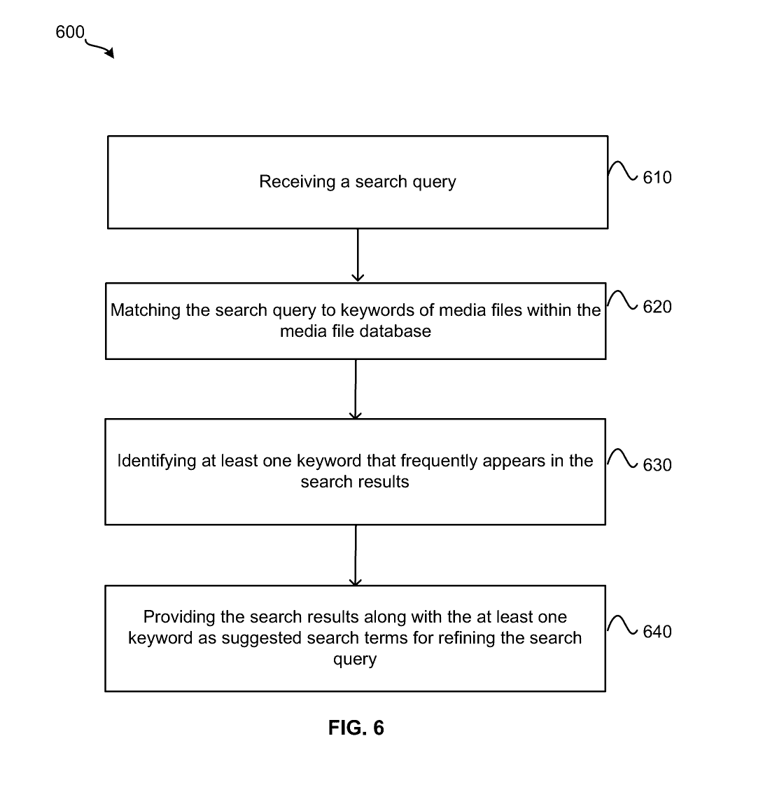

In another embodiment, a function from post process functions 135 can provide suggested search terms to the learner. The suggested search terms are recommendations for refining the search query. For example, the function may provide suggested search terms “pie,” “cookies,” and “cake” in response to a search query for “desserts.” FIG. 6 illustrates a process flow for deriving suggested search terms from a search query according to one embodiment. Process 600 can be implemented as a function within post process functions 135 or database functions 142. Process 600 can begin by receiving a search query at 610. The search query can contain one or more words or phrases. Process 600 can then generate the search results based on the search query at 620. In one embodiment, the search results can be generated by matching the search query to keywords of media files within the media content database 140. In another embodiment, the search results can be generated by matching the search query to the transcript that corresponds with the media files within the media content database 140. Media files associated with a transcript having a high score are identified as a search result.

The search result includes a collection of media files that scored highly in the search. Each media file can be associated with multiple keywords. Once the search results have been generated, process 600 can identify at least one keyword which frequently appears in the collection of media files that make up the search result. Keywords that appear frequently can be provided along with the search results as suggested search terms for refining the search at 640. This technique assists a learner in drilling down and exploring media within the media content database 140 by providing recommendations on what to search for.

### Exploring a Search Result

When a particular media search result is selected, the system can navigate from main page 500 to a media details page describing the media file. The media details page can include many features which assist a learner in quickly summarizing the media search result. These features, which are described below, can help the learner quickly determine whether this particular media is of interest to the learner.

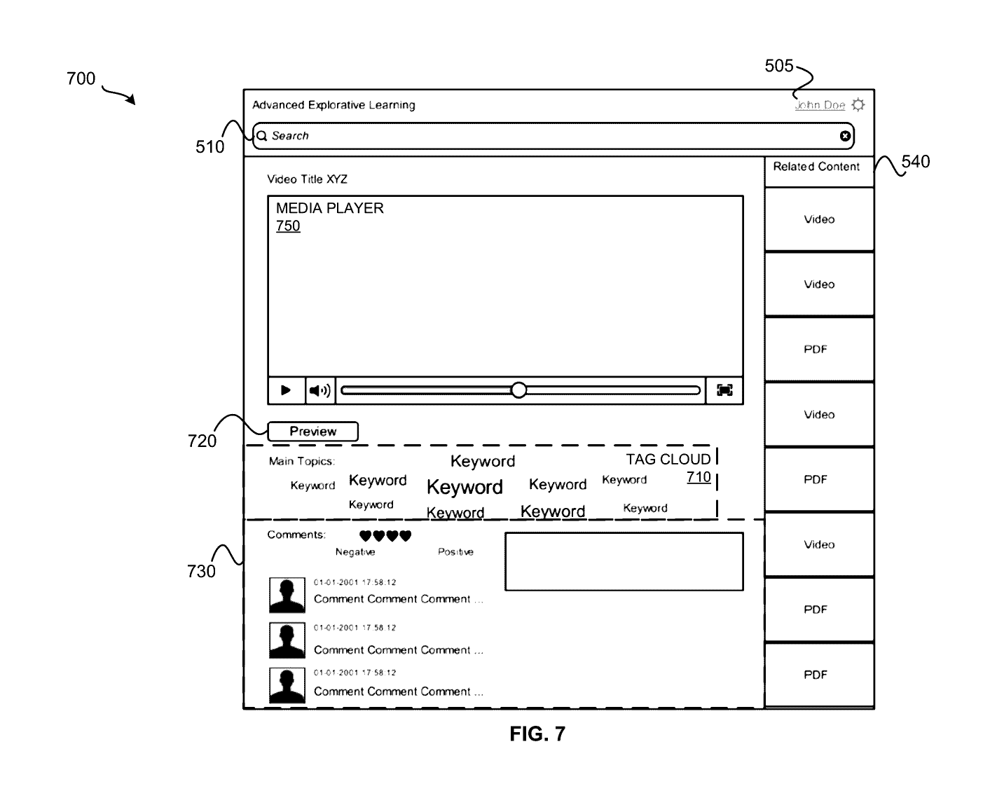

FIG. 7 illustrates a media details page according to one embodiment. Media details page 700 can be generated by UI framework 120 according to data received from web application server 130. As shown here, media details page 700 has features including tag cloud 710, preview link 720, comments section 730, and relevant content section 740. Each feature can be generated through one or more functions within UI framework 120, post process functions 135, and/or database functions 142.

Tag cloud 710 can be generated by a cloud function configured to fetch the top keywords that are associated with the selected media file. Each keyword associated with a media file can be assigned a score or ranking which signifies the importance of the keyword in the media file. For example, a keyword which is repeated 100 times during a video may be more important than another keyword which is repeated 20 times during the video. In one example, the score can be based on the number of instances in which the keyword appears in the video. The cloud function can generate a graphical representation of the top keywords within tag cloud 710. The position, orientation, or visual appearance of the keyword can be altered based on the keywords ranking or score. For example, a keyword with a higher rank or score can be presented in a larger font than a keyword with a lower rank or score.

Preview link 720, when selected, can trigger a preview function configured to generate a trailer of the media file. In one embodiment, the trailer can be a composition of portions of the media file containing the top keywords of the media file. To generate the trailer, the preview function can query the entries of the transcript for occurrences of the top keywords. For example, the preview function can identify entries having top keywords in the text field. For each identified entry, the preview function can retrieve and add the section of the media file that corresponds with the identified entry to the preview. In one example, the identified section of the media file can be located from the start time and end time of the identified entry. In other embodiments, the trailer can be a composition of sections of the medial file that contain the search query. Similar to the top keywords embodiment, the preview function can query the entries of the transcript for occurrences for occurrences of the search query. The identified entries can be combined to generate the trailer.

Comments section 730 can include comments on the medial file which have been left by other learners. Related content window 740 can include suggestions of other media which are related to the selected search result. A related content function can generate the suggestions which are presented within related content window 740. In one embodiment, the related content function can identify relevant media by using a ‘cosine similarity’ measure. Cosine similarity is a measure of similarity between two vectors and is calculated by measuring the cosine of the angle between the two vectors. Here, the related content function can assign or generate a media vector for each media file. The related content function can generate a media vector having vector components that are the keywords of the media file. The magnitude of each vector component can be a count of the number of occurrences of the keyword in the media file. Related content function can then then calculate the cosine of the angle between the media vector of the particular media result and every other media vector. If the cosine between two media vectors is 1, then the angle between the two media vectors is zero degrees (meaning that the ‘angle’ between the two is 0 degrees and that the media vectors are exactly the same.) Thus, the closer the cosine similarity measure between two media files is to 1, the higher is the similarity between the two. The related content function can identify strongly related content by identifying media files which have a cosine similarity measure that is close to 1. The identified media files can be presented within related content window 540. The learner can select a media file from related content window 540 if the learner is interested in the topics discussed in the media file being played in the media player.

### Playing Back the Media

Media details page 700 of FIG. 7 includes media player 750 for playback of the media file. Media player 750 can be configured to play back audio and video files. Media player 750 can also include features which enhance the manner in which the media file can be consumed. Features such as cue points and hot zones can be provided to the learner. These features are described below.

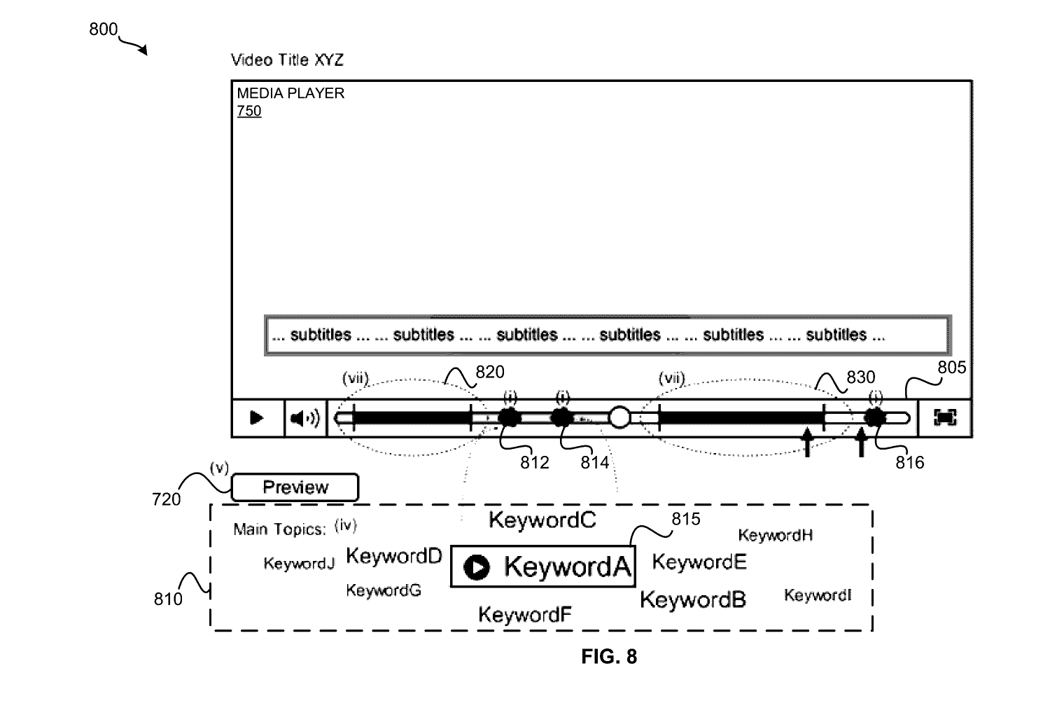

FIG. 8 illustrates a portion of a media details page according to one embodiment. As shown, portion 800 includes media player 750, preview icon 720, and tag cloud 810. Tag cloud 810 can present a plurality of keywords associated with the media file. Each of the keywords can be selectable. Upon selection of a keyword, a cue point function (within UI framework 120, post process functions 135, or database functions 142) can generate cue points to be presented on timeline 805 of media player 750. Timeline 805 of media player 750 displays the current playback position of the media file being played in media player 750. A learner can fast forward or rewind playback of the media file by performing touch gestures on the timeline.

In one embodiment, the cue point function can determine the keyword within tag cloud 810 that has been selected. In response to the selection, the cue point function can analyze the transcript of the media file to determine time stamps within the media file where the keyword is heard. The cue point function can then generate cue points along timeline 805 where the keywords are heard. The cue points can be a visual indicator such as highlighting which is used to visually indicate to the learner where the keywords appear in the media file. A touch gesture detected at or near a cue point can result in the media player skipping to a part of the media file where the keyword is mentioned. In some examples, the media player can slightly rewind the media so that the learner can determine the context in which the keyword is being used. For example, the media player can rewind a few seconds or to the beginning of the sentence so that the learner. As shown here, keyword 815 has been selected. Upon selection of keyword 815, cue points 812, 814, and 816 appear along timeline 805. Thus, the keyword is used three times in the media. Selection of any of these cue points can start playback of the media at or near when the keyword is used.

In one embodiment, a hot zone function can analyze user's viewing patterns of the media to determine sections of the media (video or audio) that are played back more frequently than other sections. For example, a chase scene or iconic scene in a movie may have more views than other scenes. Hot zone function can analyze viewing history to identify these popular sections of the media. Once identified, the hot zone function can generate a visual indicator along timeline 805 to highlight these sections. In one example, these popular sections can be presented with a red overlay. When a touch gesture (or other use input) is received on the overlay, playback of the media can resume at the popular section. Here, sections 820 and 830 identify the popular sections with a highlighted overlay positioned along timeline 805. The visual indicator used to highlight popular sections can be different than the visual indicator used to highlight cue points.

FIG. 6 is an example flow chart illustrating a process for presenting a discussion thread, in accordance with one embodiment. Process 600 can implemented within a computer system to generate a graphical representation of the discussion thread. In one embodiment, the computer system is equipped with one or more processors and memory storing one or more programs for execution by the one or more processors. One processor can be implemented as discussion thread engine 115 shown in FIG. 1. Process 600 begins by receiving, by a processor, a discussion thread that includes a plurality of first level posts and a reply grouping that contains a plurality of second level posts at step 610. Each of the second level posts can be made in response to (or in reply to) a first level post or another second level post.

After receiving the discussion thread, process 600 can continue by presenting, by the processor, the plurality of first level posts according to a first sorting order at 620. The first sorting order can be defined by the viewer as one of oldest-first sorting order, newest-first sorting order, most-likes-first sorting order, and most-responses-first sorting order. In one embodiment, the process can include first sorting the first level posts according to the first sorting order. The sorted first level posts can then be presented in accordance to a presentation scheme. For example, the presentation scheme can specify the manner in which first level posts are presented within the graphical representation.

After presenting the first level posts, process 600 can continue by presenting, by the processor, at least some of the plurality of second level posts from the plurality of first level posts according to a second sorting order that is different than the first sorting order at 630. In one embodiment, process 600 can first sort the second level posts according to the second sorting order and then present the sorted second level posts. The second level posts can be presented in accordance to the presentation scheme. For example, the presentation scheme can specify that second level posts appear slightly indented from the first level post which the second level post is generated in response to, either directly or indirectly. The presentation of the first level posts and the second level posts can form the graphical representation. In some embodiments, the presentation scheme can specify rules that define when and how posts within the discussion thread are hidden from the graphical representation to reduce the size of the graphical representation. For example, one rule can specify that posts which have been read by the viewer are hidden to minimize the size of the graphical representation. The rule can be applied automatically or when the graphical representation is larger than the display area. Advantages of reducing the size of the graphical representation so that it fits within the display area include prioritizing what is shown in the display area to posts which are new to the viewer. Furthermore, by fitting the graphical representation into the display area, scrolling tools can be avoided, thus simplifying the user interface for the viewer. In one embodiment, the process can also generate an “in reply to” link for posts which were generated in response to another post (e.g., parent post). Selecting the link can cause the parent post to be displayed within the display area. Advantages of the “in reply to” link include simultaneously presenting the child post and the parent post within the display area so that the viewer can obtain context to the content within the child post.

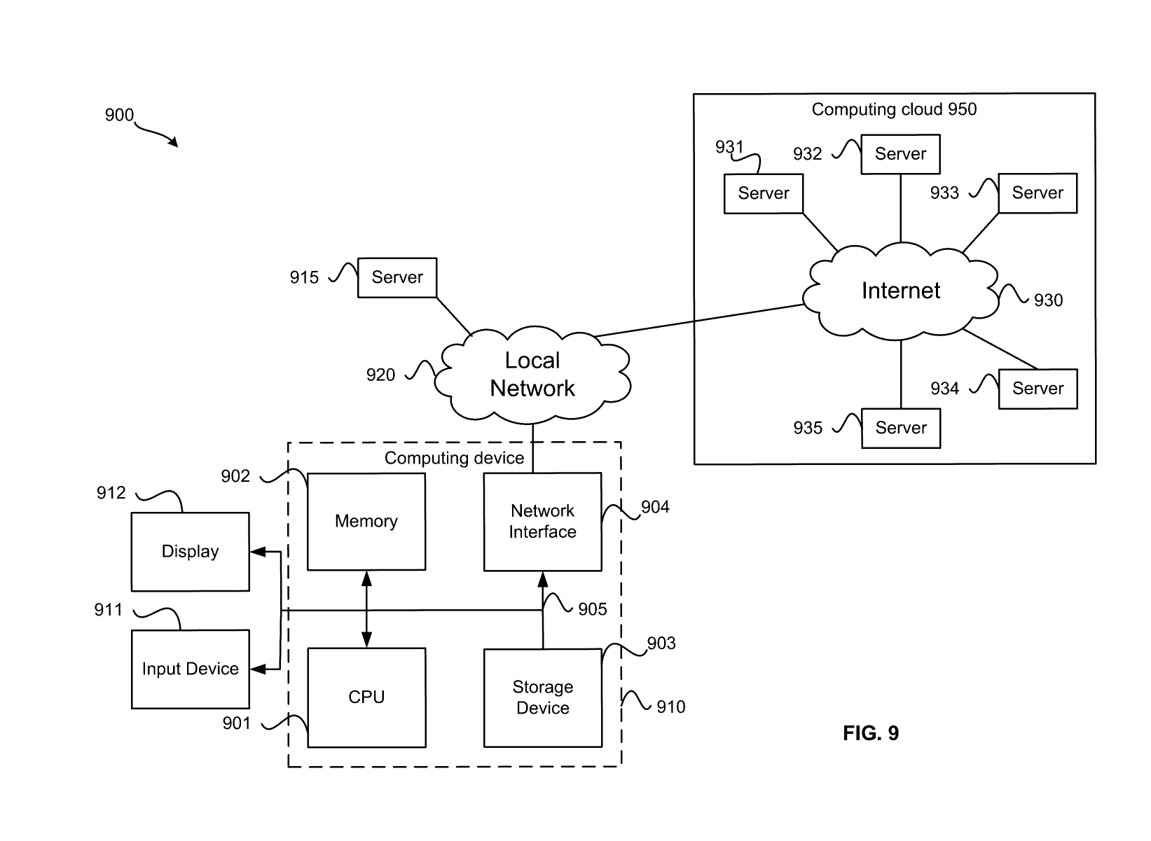

FIG. 9 is an example block diagram illustrating an example computing system for debugging in a production environment, in accordance with one embodiment. As shown in FIG. 9, in one embodiment, the computing system 910 includes a bus 906 or other communication mechanism for communicating information, and a processor 901 coupled with the bus 905 for processing information. In one embodiment, the computing system 910 also includes a memory 902 coupled to bus 906 for storing information and instructions to be executed by processor 901, including information and instructions for performing the techniques described above, for example. In one embodiment, the memory 902 may also be used for storing variables or other intermediate information during execution of instructions to be executed by processor 901. In one embodiment, the memory 902 includes, but is not limited to, random access memory (RAM), read only memory (ROM), or both. A storage device 903 is also provided for storing information and instructions. Common forms of storage devices include, for example, a hard drive, a magnetic disk, an optical disk, a CD-ROM, a DVD, a flash memory, a USB memory card, or any other medium from which a computing system can obtain information. In one embodiment, the storage device 903 may include source code, binary code, or software files for performing the techniques above, for example. The storage device 903 and the memory 902 are both examples of computer readable mediums.

In one embodiment, the computing system 910 may be coupled via the bus 906 to a display 912, such as a cathode ray tube (CRT) or liquid crystal display (LCD), for displaying information to a user. An input device 911 such as a keyboard and/or mouse is coupled to the bus 905 for communicating information and command selections from the user to the processor 901. The combination of these components allows the user to communicate with the computing system 910. In some systems, the bus 906 may be divided into multiple specialized buses.

In one embodiment, the computing system 910 includes a network interface 904 coupled with the bus 905. In one embodiment, the network interface 904 provides two-way data communications between the computing system 910 and the local network 920. In one embodiment, the network interface 907 includes a digital subscriber line (DSL) or a modem to provide data communication connection over a telephone line, for example. Another example of the network interface 904 is a local area network (LAN) card to provide a data communication connection to a compatible LAN. Wireless links are another example. In any such implementation, the network interface 904 sends and receives electrical, electromagnetic, or optical signals that carry digital data streams representing various types of information.

In one embodiment, the computing system 910 sends and receives information, including messages or other interface actions, through the network interface 904 across a local network 920, an Intranet, or the Internet 930. In one embodiment, the local network, the computing system 910 communicates with a plurality of other computer machines, such as a server 915 or a computing cloud 950. In one embodiment, the computing system 910 and server computer systems represented by the server 915 form a cloud computing network, which may be programmed with processes described herein. In the Internet example, software components or services may reside on multiple different computing systems 910 or servers 931-935 across the network. In one embodiment, the processes described above are implemented at computing cloud 950, which includes one or more servers from the servers 931-935. In one embodiment, the server 931 transmits actions or messages from one component, through the Internet 930, the local network 920, and the network interface 904 to a component of the computing system 910. In one embodiment, the software components and processes described above are implemented on any computer system and send and/or receive information across a network.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first request could be termed a second request, and, similarly, a second request could be termed a first request, without changing the meaning of the description, so long as all occurrences of the “first request” are renamed consistently and all occurrences of the “second request” are renamed consistently. The first request and the second request are both requests, but they are not the request.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What claimed is:

1. A computer-implemented method comprising:
receiving, by a processor, a request to generate a preview of a media file;
identifying, by the processor, a keyword associated with the media file;
capturing, by the processor, at least one snippet from the media file in accordance to the keyword; and
combining, by the processor, the at least one snippet into a preview file, wherein the preview file is configured to provide a summary of the media file.

2. The computer-implemented method of claim 1, wherein the keyword characterizes the media file.

3. The computer-implemented method of claim 1, wherein capturing the at least one snippet comprises:
retrieving, by the processor, a transcript containing a text version of audible content within the media file; and
querying, by the processor, the transcript to identify an entry within the transcript that contains the keyword.

4. The computer-implemented method of claim 3, wherein the transcript includes a plurality of entries, wherein the entry includes text that transcribes a snippet of the media file, a start time describing when an audible version of the text begins within the media file, and an end time describing when the audible version of the text ends within the media file.

5. The computer-implemented method of claim 4, wherein capturing the at least one snippet from the media file further comprises copying, by the processor, the snippet from the media file based on the start and the end time of the entry.

6. The computer-implemented method of claim 5, wherein the snippet comprises a portion of the media file that begins at the start time and ends at the end time.

7. The computer-implemented method of claim 4, wherein combining the at least one snippet into the preview file comprises:
determining, by the processor, an insertion point for the snippet into the preview file which would maintain the chronological ordering of other snippets within the preview file; and
inserting, by the processor, the snippet at the insertion point.

8. A non-transitory computer readable storage medium storing one or more programs, the one or more programs comprising instructions, which when executed by a processor, cause the processor to execute a method of:
receiving a request to generate a preview of a media file;
identifying a keyword associated with the media file;
capturing at least one snippet from the media file in accordance to the keyword; and
combining the at least one snippet into a preview file, wherein the preview file is configured to provide a summary of the media file.

9. The non-transitory computer readable storage medium of claim 8, wherein the wherein the keyword characterizes the media file.

10. The non-transitory computer readable storage medium of claim 8, wherein capturing the at least one snippet comprises:
retrieving a transcript containing a text version of audible content within the media file; and
querying the transcript to identify an entry within the transcript that contains the keyword.

11. The non-transitory computer readable storage medium of claim 10, wherein the transcript includes a plurality of entries, wherein the entry includes text that transcribes a snippet of the media file, a start time describing when an audible version of the text begins within the media file, and an end time describing when the audible version of the text ends within the media file.

12. The non-transitory computer readable storage medium of claim 11, wherein capturing the at least one snippet from the media file further comprises copying the snippet from the media file based on the start and the end time of the entry.

13. The non-transitory computer readable storage medium of claim 12, wherein the snippet comprises a portion of the media file that begins at the start time and ends at the end time.

14. The non-transitory computer readable storage medium of claim 12, wherein combining the at least one snippet into the preview file comprises:
determining an insertion point for the snippet into the preview file which would maintain the chronological ordering of other snippets within the preview file; and
inserting the snippet at the insertion point.

15. A computer implemented system, comprising:
one or more computer processors; and
a non-transitory computer-readable storage medium comprising instructions, that when executed, control the one or more computer processors to be configured for:
receiving a request to generate a preview of a media file;
identifying a keyword associated with the media file;
capturing at least one snippet from the media file in accordance to the keyword; and
combining the at least one snippet into a preview file, wherein the preview file is configured to provide a summary of the media file.

16. The computer implemented system of claim 15, wherein the wherein the keyword characterizes the media file.

17. The computer implemented system of claim 15, wherein capturing the at least one snippet comprises:
retrieving a transcript containing a text version of audible content within the media file; and
querying the transcript to identify an entry within the transcript that contains the keyword.

18. The computer implemented system of claim 17, wherein the transcript includes a plurality of entries, wherein the entry includes text that transcribes a snippet of the media file, a start time describing when an audible version of the text begins within the media file, and an end time describing when the audible version of the text ends within the media file.

19. The computer implemented system of claim 18, wherein capturing the at least one snippet from the media file further comprises copying the snippet from the media file based on the start and the end time of the entry.

20. The computer implemented system of claim 18, wherein the snippet comprises a portion of the media file that begins at the start time and ends at the end time.
